(19) United States
(12) Patent Application Publication
(10) Pub. No.: US 2025/0300574 A1
(43) Pub. Date: Sep. 25, 2025

(54) POWER CONVERSION DEVICE

(71) Applicant: Denso Corporation, Kariya-city (JP)

(72) Inventors: Seido ARAKI, Kariya-city (JP); Hiroaki Sato, Kariya-city (JP); Keiji Hinata, Kariya-city (JP)

(73) Assignee: DENSO CORPORATION, Kariya-city (JP)

(21) Appl. No.: 19/225,287

(22) Filed: Jun. 2, 2025

Related U.S. Application Data
(63) Continuation of application No. PCT/JP2023/044192, filed on Dec. 11, 2023.

(30) Foreign Application Priority Data
Jan. 17, 2023 (JP) 2023-005267

(51) Int. Cl. H02M 7/483

(52) U.S. Cl. CPC H02M 7/483

(57) ABSTRACT

An inverter circuit is a three-level inverter circuit. The inverter circuit includes: a P bus bar connected to a high-potential terminal of a battery; an N bus bar connected to a low-potential terminal of the battery; and an M bus bar having a potential between the P bus bar and the N bus bar. The inverter circuit includes: a PM capacitor connected to the P bus bar and the N bus bar; a MN capacitor connected to the N bus bar and the M bus bar; and a semiconductor device connected to the M bus bar. The M bus bar is a part between (i) the second power module and (ii) the PM capacitor and the MN capacitor, is arranged between the P bus bar and N bus bar, and has a base portion opposing the P bus bar and N bus bar.

### CROSS REFERENCE TO RELATED APPLICATION

The present application is a continuation application of International Patent Application No. PCT/JP2023/044192 filed on Dec. 11, 2023, which designated the U.S. and claims the benefit of priority from Japanese Patent Application No. 2023-005267 filed on Jan. 17, 2023. The entire disclosures of all of the above applications are incorporated herein by reference.

### TECHNICAL FIELD

The present disclosure relates to an electric power conversion device.

### BACKGROUND

As an example of a conventional multilevel inverter, a three-level inverter including a cooling fin base is disclosed in a relevant art. In the three-level inverter, a midpoint wiring is divided into two parts with the cooling fin base interposed therebetween. Therefore, in the three-level inverter, an inductance between a high-potential wiring and a low-potential wiring becomes large.

### SUMMARY

A power conversion device according to an aspect of the present disclosure is capable of dividing an input DC voltage into a plurality of values and outputting a plurality of levels of voltage through an output wiring. The power conversion device may include: a high-potential wiring connected to a positive electrode of a power source; a low-potential wiring connected to a negative electrode of the power source; at least one midpoint wiring having a potential between the high-potential wiring and the low-potential wiring; a first power module connected to the high-potential wiring, the low-potential wiring, and the output wiring; a first capacitor having a high potential electrode connected to the high-potential wiring and a first midpoint electrode connected to the midpoint wiring; a second capacitor having a low potential electrode connected to the low-potential wiring and a second midpoint electrode connected to the midpoint wiring; and a second power module connected to the midpoint wiring and the output wiring. For example, the at least one midpoint wiring may be a part between (i) the second power module and (ii) the first capacitor and the second capacitor, may be arranged between the high-potential wiring and the low-potential wiring, and may have an opposing portion opposing the high-potential wiring and the low-potential wiring.

### BRIEF DESCRIPTION OF THE DRAWINGS

Objects, features, and advantages of the present disclosure will become more apparent from the following detailed description made with reference to the accompanying drawings, in which:

FIG. 1 is a circuit diagram showing a schematic configuration of an inverter circuit according to a first embodiment;

FIG. 2 is a cross-sectional view showing a schematic configuration of the inverter circuit;

FIG. 3 is a cross-sectional view taken along a line III-III in FIG. 2;

FIG. 4 is a plan view seen from a direction of an arrow IV in FIG. 2;

FIG. 5 is a perspective view showing a schematic configuration of the inverter circuit;

FIG. 6 is a cross-sectional view showing a schematic configuration of a capacitor device according to a second embodiment;

FIG. 7 is a cross-sectional view showing a schematic configuration of a capacitor device according to a third embodiment;

FIG. 8 is a cross-sectional view showing a schematic configuration of a capacitor device according to a fourth embodiment;

FIG. 9 is a plan view showing a schematic configuration of a capacitor device according to a fifth embodiment;

FIG. 10 is a cross-sectional view taken along a line X-X of FIG. 9;

FIG. 11 is a cross-sectional view taken along line XI-XI in FIG. 9;

FIG. 12 is a plan view showing a schematic configuration of a capacitor device according to a sixth embodiment;

FIG. 13 is a circuit diagram showing a schematic configuration of an inverter circuit according to a seventh embodiment;

FIG. 14 is a cross-sectional view showing a schematic configuration of an inverter circuit;

FIG. 15 is a perspective view showing an arrangement of a capacitor device;

FIG. 16 is a perspective view showing an arrangement of a capacitor device according to an eighth embodiment;

FIG. 17 is a cross-sectional view showing a schematic configuration of an inverter circuit according to a ninth embodiment;

FIG. 18 is a cross-sectional view showing a schematic configuration of an inverter circuit according to a tenth embodiment;

FIG. 19 is a cross-sectional view showing a schematic configuration of an inverter circuit according to an eleventh embodiment; and

FIG. 20 is a cross-sectional view showing a schematic configuration of an inverter circuit according to a twelfth embodiment.

### DESCRIPTION OF EMBODIMENTS

As an example of a multilevel inverter, a three-level inverter is disclosed. The three-level inverter includes a cooling fin base, a first switching function element, a first diode, a second switching function element, a fourth switching function element, a second diode, a third switching function element, and a connection plate. Further, the three-level inverter is provided with the first switching function element, the first diode, the second switching function element, the fourth switching function element, the second diode, and the third switching function element arranged on both sides of the cooling fin base with their back surfaces facing each other. In the three-level inverter, each switching function element and each diode are connected by the connection plate that is provided to face the three surfaces of the cooling fin base.

In the three-level inverter, a midpoint wiring is divided into two parts with the cooling fin base interposed therebetween. Therefore, the three-level inverter has a problem in that an inductance between a high-potential wiring and a low-potential wiring becomes large. Further, improvements are required in the power conversion device in the above-described aspects and in other aspects not mentioned above.

It is an object of the present disclosure to provide a power conversion device having reduced inductance.

A power conversion device according to an aspect of the present disclosure is capable of dividing an input DC voltage into a plurality of values and outputting a plurality of levels of voltage through an output wiring. The power conversion device may include: a high-potential wiring connected to a positive electrode of a power source; a low-potential wiring connected to a negative electrode of the power source; at least one midpoint wiring having a potential between the high-potential wiring and the low-potential wiring; a first power module connected to the high-potential wiring, the low-potential wiring, and the output wiring; a first capacitor having a high potential electrode connected to the high-potential wiring and a first midpoint electrode connected to the midpoint wiring; a second capacitor having a low potential electrode connected to the low-potential wiring and a second midpoint electrode connected to the midpoint wiring; and a second power module connected to the midpoint wiring and the output wiring. In the power conversion device, the at least one midpoint wiring may be a part between (i) the second power module and (ii) the first capacitor and the second capacitor, may be arranged between the high-potential wiring and the low-potential wiring, and may have an opposing portion opposing the high-potential wiring and the low-potential wiring.

In the power conversion device according to the aspect of the present disclosure, the midpoint wiring is arranged between the high-potential wiring and the low-potential wiring, and has the opposing portion opposing the high-potential wiring and the low-potential wiring. Therefore, the power conversion device can cancel out a magnetic field at a position between the high-potential wiring and the opposing portion of the midpoint wiring, and also at a position between the opposing portion of the midpoint wiring and the low-potential wiring. Thus, the power conversion device can effectively reduce an inductance.

The disclosed multiple exemplars in the specification adopt different technical solutions from each other in order to achieve their respective objects. Reference numerals in parentheses described in claims and this section exemplarily show corresponding relationships with parts of embodiments to be described later and are not intended to limit technical scopes. The objects, features, and advantages disclosed in the specification will become apparent by referring to following detailed descriptions and accompanying drawings.

Multiple embodiments for implementing the present disclosure will be described in the following with reference to the drawings. In each of the embodiments, portions corresponding to those described in the preceding embodiment are denoted by the same reference numerals, and redundant descriptions will be omitted in some cases. In each of the embodiments, when only a part of the configuration is explained, the other embodiment previously explained is applicable regarding the other part of such embodiment.

### First Embodiment

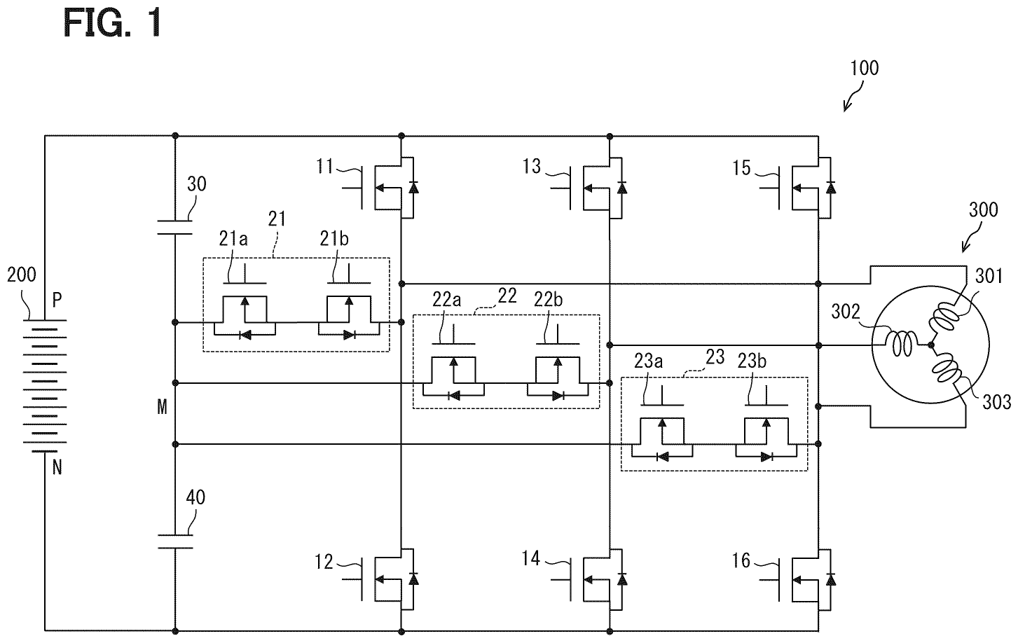

An inverter circuit 100 according to a first embodiment will be described with reference to FIGS. 1 to 5. The inverter circuit 100 is configured to be capable of dividing an input DC voltage into a plurality of values and outputting voltages at a plurality of levels. The inverter circuit 100 is a so-called multilevel inverter. Whereas a two-level inverter can output voltages of +E, −E, 0 and two levels other than 0, assuming that the voltage of a battery 200 is E, a multilevel inverter can output voltages of three or more levels. In the present embodiment, a three-level inverter circuit 100 is used as an example.

The inverter circuit 100 can be mounted on a moving object such as a vehicle or an aircraft. As shown in FIG. 1, the inverter circuit 100 is electrically connected to the battery 200 and a motor 300. The motor 300 is a three-phase motor including a U-phase coil 301, a V-phase coil 302, and a W-phase coil 303. The motor 300 may be, for example, a motor generator or the like. The inverter circuit 100 converts a DC power output by the battery 200 into three-phase AC power, and supplies the three-phase AC power to the motor 300. The inverter circuit 100 corresponds to a power conversion device.

### Circuit Configuration of Inverter Circuit 100

The circuit configuration of the inverter circuit 100 will be described with reference to FIG. 1. The inverter circuit 100 includes switching elements 11 to 16, a U-phase middle section 21, a V-phase middle section 22, a W-phase middle section 23, a capacitor device 60, and the like. In FIG. 1, a PM capacitor 30 and an MN capacitor 40 included in the capacitor device 60 are illustrated.

The switching elements 11 to 16 may be MOSFETs, IGBTs, or the like. Moreover, the switching elements 11 to 16 may be made mainly of a wide band gap semiconductor such as Si or SiC. The switching elements 11 to 16 have their gate electrodes connected to an electronic control device (not shown). The switching elements 11 to 16 are controlled and driven by the electronic control device.

The switching elements 11 to 16 include a U-phase upper arm element 11, a U-phase lower arm element 12, a V-phase upper arm element 13, a V-phase lower arm element 14, a W-phase upper arm element 15, and a W-phase lower arm element 16.

The U-phase upper arm element 11 and the U-phase lower arm element 12 are connected in series between a high-potential terminal (P) and a low-potential terminal (N) of the battery 200. A source terminal of the U-phase upper arm element 11 and a drain terminal of the U-phase lower arm element 12 are connected to the U-phase coil 301. The U-phase upper arm element 11 and the U-phase lower arm element 12 can be collectively referred to as a U-phase arm.

The V-phase upper arm element 13 and the V-phase lower arm element 14 are connected in series between the high-potential terminal and the low-potential terminal of the battery 200. The source terminal of the V-phase upper arm element 13 and the drain terminal of the V-phase lower arm element 14 are connected to the V-phase coil 302. The V-phase upper arm element 13 and the V-phase lower arm element 14 can be collectively referred to as a V-phase arm.

The W-phase upper arm element 15 and the W-phase lower arm element 16 are connected in series between the high-potential terminal and the low-potential terminal of the battery 200. The source terminal of the W-phase upper arm element 15 and the drain terminal of the W-phase lower arm element 16 are connected to the W-phase coil 303. The W-phase upper arm element 15 and the W-phase lower arm element 16 can be collectively referred to as a W-phase arm.

In such manner, each arm is connected in series between a P bus bar 71 and an N bus bar 72, which will be described later. With respect to a structure of the switching elements 11 to 16, the battery 200, which will be described later, corresponds to a power source. The high-potential terminal corresponds to a positive electrode. The low-potential terminal corresponds to a negative electrode.

The U-phase middle section 21, the V-phase middle section 22, and the W-phase middle section 23 are connected to a midpoint (neutral point) M between a high potential and a low potential and to each arm. Each of the middle sections 21 to 23 includes two switching elements. The switching elements may be the same as the switching elements 11 to 16 described above. The switching elements have their gate electrodes connected to the electronic control device. The switching elements are driven and controlled by the electronic control device. The midpoint M can be designated as a portion of intermediate potential between the high potential and the low potential. Further, the midpoint M is a portion between the PM capacitor 30 and the MN capacitor 40.

The U-phase middle section 21 includes a first U-phase middle element 21a and a second U-phase middle element 21b as switching elements. The first U-phase middle element 21a has a drain terminal connected to the midpoint M, and a source terminal connected to the source terminal of the second U-phase middle element 21b. The drain terminal of the second U-phase middle element 21b is connected to the source terminal of the U-phase upper arm element 11 and the drain terminal of the U-phase lower arm element 12.

The V-phase middle section 22 includes a first V-phase middle element 22a and a second V-phase middle element 22b as switching elements. The first V-phase middle element 22a has the drain terminal connected to the midpoint M, and the source terminal connected to the source terminal of the second V-phase middle element 22b. The drain terminal of the second V-phase middle element 22b is connected to the source terminal of the V-phase upper arm element 13 and the drain terminal of the V-phase lower arm element 14.

The W-phase middle section 23 includes a first W-phase middle element 23a and a second W-phase middle element 23b as switching elements. The first W-phase middle element 23a has the drain terminal connected to the midpoint M, and the source terminal connected to the source terminal of the second W-phase middle element 23b. The drain terminal of the second W-phase middle element 23b is connected to the source terminal of the W-phase upper arm element 15 and the drain terminal of the W-phase lower arm element 16. The structures of the U-phase middle section 21, the V-phase middle section 22, and the W-phase middle section 23 will be described later.

The capacitor device 60 includes the PM capacitor 30 and the MN capacitor 40 as smoothing capacitors. The PM capacitor 30 is connected between the high-potential terminal and the midpoint M. The MN capacitor 40 is connected between the midpoint M and the low-potential terminal. Therefore, the PM capacitor 30 and the MN capacitor 40 are connected in series.

The PM capacitor 30 and the MN capacitor 40 are provided mainly for voltage stabilization and current ripple absorption. In other words, the PM capacitor 30 and the MN capacitor 40 are provided to suppress an allowable voltage fluctuation at the midpoint M and to reduce the current ripple that flows out of the inverter circuit 100. The PM capacitor 30 corresponds to a first capacitor. The MN capacitor 40 corresponds to a second capacitor.

The present disclosure is also applicable to a diode clamp type (T type) inverter circuit 100. The present disclosure is also usable with an inverter circuits 100 having N levels or more (N=4). In such case, the intermediate potential is N−2.

### Structure of Inverter Circuit 100

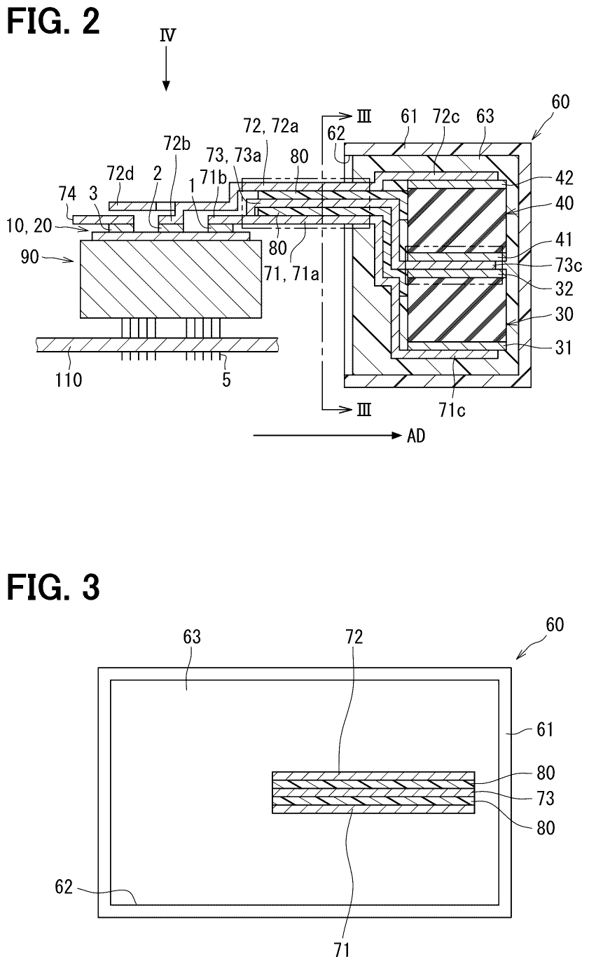

The structure of the inverter circuit 100 will be described with reference to FIGS. 2 to 5. In the inverter circuit 100, the capacitor device 60 and a structured body in which semiconductor devices 10 and 20 and a cooler 90 are integrally assembled are arranged side by side. In the drawing, an arrangement direction of the capacitor device 60 and the structured body is indicated by an arrow AD.

Further, as shown in FIGS. 2 to 5 and the like, the inverter circuit 100 includes the bus bars 71 to 74 that connect the capacitors 30 to 50 to the semiconductor devices 10 and 20, respectively. The bus bars 71 to 74 are conductive members whose main component is copper or the like. The bus bars 71 to 74 are flat plate-shaped members. Each of the bus bars 71 to 74 is formed from a single flat plate-shaped member. It can also be said that each of the bus bars 71 to 74 is formed, for example, by bending a single metal plate.

The P bus bar 71 is connected to the high-potential terminal. The terminal connected to the high-potential terminal is thus connected to the P bus bar 71. The P bus bar 71 corresponds to a high-potential wiring.

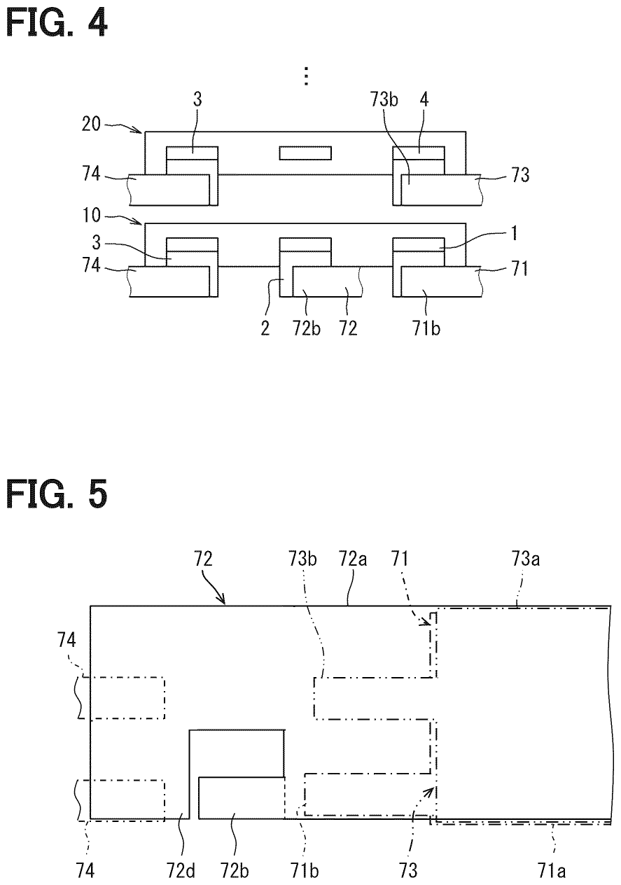

As shown in FIGS. 2 and 4, the P bus bar 71 has a base portion 71a, a switch connection portion 71b connected to the base portion 71a, and a capacitor connection portion 71c connected to the base portion 71a. The base portion 71a is a base portion that is connected to the switch connection portion 71b and the capacitor connection portion 71c. The switch connection portion 71b is connected to a P terminal 1 of the semiconductor device 10, which will be described later. The capacitor connection portion 71c is connected to a first PM terminal 31 of the PM capacitor 30, which will be described later.

The N bus bar 72 is connected to the low-potential terminal. The terminal connected to the low-potential terminal is connected to the N bus bar 72. The N bus bar 72 corresponds to a low-potential wiring.

As shown in FIGS. 2 and 4, the N bus bar 72 has a base portion 72a, a switch connection portion 72b connected to the base portion 72a, and a capacitor connection portion 72c connected to the base portion 72a. The base portion 72a is a base portion that is connected to the switch connection portion 72b and the capacitor connection portion 72c. The switch side connection portion 72b is connected to an N terminal 2 of the semiconductor device 10. The capacitor connection portion 72c is connected to a second MN terminal 42 of the MN capacitor 40, which will be described later.

Further, as shown in FIG. 5, the N bus bar 72 has an extension portion 72d. The extension portion 72d is a portion that is connected to the base portion 72a and is extended onto the O bus bar 74. The extension portion 72d is arranged to oppose the O bus bar 74. In FIG. 4, in order to simplify the drawing, the extension portion 72d is omitted. The N bus bar 72 does not have to have the extension portion 72d.

The M bus bar 73 configures the midpoint M. The M bus bar 73 has a potential between the P bus bar 71 and the N bus bar 72. The M bus bar 73 is connected to the PM capacitor 30 and the MN capacitor 40. A terminal connected to the midpoint M is thus connected to the M bus bar 73. The M bus bar 73 corresponds to a midpoint wiring. In the present embodiment, a configuration including one M bus bar 73 is adopted. However, the present disclosure is not limited to such configuration. The configuration may have at least one M bus bar 73 provided therein. The number of M bus bars 73 varies depending on the number of output levels of the inverter circuit 100.

As shown in FIGS. 2 and 4, the M bus bar 73 has a base portion 73a, a switch connection portion 73b connected to the base portion 73a, and a capacitor connection portion 73c connected to the base portion 73a. The base portion 73a is a base portion that is connected to the switch connection portion 73b and the capacitor connection portion 73c. The switch connection portion 73b is connected to an M terminal 4 of the semiconductor device 20, which will be described later.

The capacitor connection portion 73c is connected to the second PM terminal 32 of the PM capacitor 30 and the first MN terminal 41 of the MN capacitor 40. That is, one surface of the capacitor connection portion 73c is connected to the second PM terminal 32, and an opposite surface of the capacitor connection portion 73c is connected to the first MN terminal 41. The capacitor connection portion 73c is commonly connected to the PM capacitor 30 and the MN capacitor 40. In such manner, in the present embodiment, as an example, the M bus bar 73 provided with only one capacitor connection portion 73c is adopted. The positional relationship between the bus bars 71 to 73 will be described in detail later.

The O bus bar 74 is an output wiring connected to an O terminal 3 of the semiconductor device 10. The inverter circuit 100 includes the O bus bar 74 connected to each of the U-phase coil 301, the V-phase coil 302, and the W-phase coil 303. The O bus bar 74 corresponds to an output wiring.

In the present embodiment, as an example, an insulating member 80 is provided to electrically insulate the components from each other. The insulating member 80 is provided between the P bus bar 71 and the M bus bar 73, and between each of the bus bars 71, 73 and the PM capacitor 30. Further, the insulating member 80 is provided between the M bus bar 73 and the N bus bar 72, and between each of the bus bars 72, 73 and the MN capacitor 40. However, when electrical insulation is possible, there is no need to provide the insulating member 80.

The semiconductor devices 10 and 20 are, for example, covered with an electrically-insulating sealing resin in a state in which two bare-chip switching elements are connected to each other. Further, as shown in FIGS. 2, 4, etc., in the semiconductor devices 10 and 20, tips of the terminals 1 to 5 protrude from the sealing resin. The inverter circuit 100 includes a plurality of semiconductor devices 10 and a plurality of semiconductor devices 20. The semiconductor devices 10 and 20 are arranged side by side and attached to the cooler 90. In FIG. 4, the cooler 90 is omitted for the sake of simplicity.

The inverter circuit 100 includes three semiconductor devices 10 constituting each arm. The U-phase arm semiconductor device 10 includes the U-phase upper arm element 11 and the U-phase lower arm element 12. The V-phase arm semiconductor device 10 includes the V-phase upper arm element 13 and the V-phase lower arm element 14. The W-phase arm semiconductor device 10 includes the W-phase upper arm element 15 and the W-phase lower arm element 16. The semiconductor device 10 also includes the P terminal 1, the N terminal 2, the O terminal 3, and the signal terminal 5. The semiconductor device 10 can also be called as an arm device. The semiconductor device 10 corresponds to a first power module.

The inverter circuit 100 includes three semiconductor devices 20 which constitute the middle sections 21 to 23. The semiconductor device 20 of the U-phase middle section 21 includes the first U-phase middle element 21a and the second U-phase middle element 21b. The semiconductor device 20 of the V-phase middle section 22 includes the first V-phase middle element 22a and the second V-phase middle element 22b. The semiconductor device 20 of the W-phase middle section 23 includes the first W-phase middle element 23a and the second W-phase middle element 23b. The semiconductor device 20 also includes the O terminal 3, the M terminal 4, and the signal terminal 5. The semiconductor device 20 can also be called as a middle device. The semiconductor device 20 corresponds to a second power module.

As shown in FIG. 4, the P terminal 1 is connected to the P bus bar 71. The N terminal 2 is connected to the N bus bar 72. The O terminal 3 is connected to the O bus bar 74. The M terminal 4 is connected to the M bus bar 73. As shown in FIG. 2, the signal terminal 5 is connected to a wiring board 110. The wiring board 110 is a board in which conductive wiring is provided on an insulating base material such as resin or the like. The wiring board 110 is connected to an electronic control device.

The cooler 90 is configured to circulate a coolant such as water in order to cool the semiconductor devices 10 and 20. The cooler 90 sandwiches the semiconductor devices 10 and 20 between the portions through which the coolant flows.

Therefore, the bus bars 71 to 74 have their switch connection portions 71b to 73b, which are connection portions connected to the terminals 1 to 4, arranged close to the cooler 90. Further, as described above, the bus bars 71 to 74 are connected to the terminals 1 to 4 of the semiconductor devices 10 and 20 that are cooled by the cooler 90. Therefore, the bus bars 71 to 74 are cooled by the cooler 90 together with the semiconductor devices 10 and 20. It can also be said that one end of the bus bars 71 to 73 is connected to the structured body and the other end of the bus bars 71 to 73 is connected to the capacitor device 60.

As shown in FIGS. 2 and 3, the capacitor device 60 includes the capacitors 30 and 40, a capacitor case 61, and a sealing resin 63. The capacitor case 61 accommodates the capacitors 30 and 40, and is a case having an opening 62 formed in a part thereof. The capacitor case 61 is provided with the sealing resin 63 in a state in which the capacitors 30 and 40 are housed. That is, the capacitor case 61 has the capacitors 30, 40 and the sealing resin 63 provided in an accommodation space. The capacitors 30 and 40 are sealed with the sealing resin 63.

Further, within the capacitor case 61, portions of the P bus bar 71, the N bus bar 72, and the M bus bar 73 is arranged for connection to the capacitors 30, 40. The portions of the P bus bar 71, the N bus bar 72, and the M bus bar 73 arranged in the capacitor case 61 are sealed with the sealing resin 63. Further, as shown in FIG. 3, the P bus bar 71, the N bus bar 72, and the M bus bar 73 protrude from the opening 62.

In such manner, the capacitor device 60 has the two capacitors 30, 40 held integrally. The capacitor device 60 may also be called as a capacitor structured body. Further, the capacitors 30 and 40 may be configured with one capacitor element, or may be configured with a plurality of capacitor elements. The capacitor element here is a film capacitor.

As shown in FIG. 2, the PM capacitor 30 includes the first PM terminal 31 and the second PM terminal 32. The first PM terminal 31 is connected to the P bus bar 71. The second PM terminal 32 is connected to the M bus bar 73. The PM capacitor 30 corresponds to a first capacitor. The first PM terminal 31 corresponds to a high-potential electrode. The second PM terminal 32 corresponds to a first midpoint electrode.

The MN capacitor 40 includes the first MN terminal 41 and the second MN terminal 42. The first MN terminal 41 is connected to the M bus bar 73. The second MN terminal 42 is connected to the N bus bar 72. The MN capacitor 40 corresponds to a second capacitor. The first MN terminal 41 corresponds to a second midpoint electrode. The second MN terminal 42 corresponds to the low potential electrode.

Further, as shown in FIGS. 2 and 5, the PM capacitor 30 and the MN capacitor 40 are in a stacked arrangement along a direction intersecting an arrangement direction AD. In the present embodiment, as an example, the PM capacitor 30 and the MN capacitor 40 in a stacked arrangement along a direction perpendicular to the arrangement direction AD.

More specifically, the PM capacitor 30 and the MN capacitor 40 are in a stacked arrangement such that the second PM terminal 32 of the PM capacitor 30 and the first MN terminal 41 of the MN capacitor 40 oppose each other. In other words, the second PM terminal 32 and the first MN terminal 41 are arranged to oppose to each other.

The capacitor connection portion 73c, which is a part of the M bus bar 73, is arranged between the PM capacitor 30 and the MN capacitor 40. The capacitor connection portion 73c is sandwiched between the PM capacitor 30 and the MN capacitor 40. The capacitor connection portion 73c is connected to the second PM terminal 32 and the first MN terminal 41. In other words, the second PM terminal 32 and the first MN terminal 41 are connected to the same M bus bar 73. The capacitor connection portion 73c corresponds to a connection portion.

Therefore, as indicated by a two-dot chain line in FIG. 2, the M bus bar 73 has the capacitor connection portion 73c that runs in parallel with the PM capacitor 30 and the MN capacitor 40. In other words, the capacitor connection portion 73c is arranged to oppose the PM capacitor 30 and the MN capacitor 40. Further, the capacitor connection portion 73c is connected to the PM capacitor 30 and the MN capacitor 40. Therefore, it can be said that the capacitor connection portion 73c and the PM capacitor 30, and the capacitor connection portion 73c and the MN capacitor 40 are arranged at positions such that the magnetic fields can be cancelled out. In such manner, the inverter circuit 100 is enabled to reduce the inductance between the second PM terminal 32 and the first MN terminal 41.

Therefore, the inverter circuit 100 has a smaller volume along the arrangement direction AD than a configuration in which the PM capacitors 30 and the MN capacitors 40 are arranged along the arrangement direction AD. It can also be said that the inverter circuit 100 has a smaller volume in a direction perpendicular to the stack direction of the PM capacitor 30 and the MN capacitor 40. Also, it can be said that the PM capacitor 30 and the MN capacitor 40 are stacked in a thickness direction of both capacitors 30, 40. Also, it can simply be said that the PM capacitor 30 and the MN capacitor 40 are in a stacked arrangement.

The thickness direction is a direction perpendicular to connection surfaces of the terminals 31 and 32 with the bus bars 71 and 73. The thickness direction is also a direction perpendicular to the connection surfaces of the terminals 41 and 42 with the bus bars 72 and 73.

### Positional Relationship of Bus Bars 71 to 73

As shown in FIGS. 2, 3 and 5, the base portion 73a of the M bus bar 73 is arranged between (a) the semiconductor device 20 and (b) the capacitors 30 and 40. A part of the base portion 73a is arranged between the P bus bar 71 and the N bus bar 72, and opposes the P bus bar 71 and the N bus bar 72. Further, the base portion 73a includes a portion facing the base portion 71a of the P bus bar 71 and the base portion 72a of the N bus bar 72. A part of the base portion 73a is arranged outside the sealing resin 63 so as to face the base portions 71a and 72a. Further, a part of the base portion 73a is also arranged inside the sealing resin 63 so as to face the base portions 71a and 72a.

It can also be said that a part of the base portion 73a runs parallel to a part of the P bus bar 71 and a part of the N bus bar 72. It can also be said that the base portion 73a is in a stacked arrangement together with the base portion 71a and the base portion 72a with the insulating member 80 interposed therebetween. The base portion 73a is stacked (facing) in a short distance to the base portion 71a and the base portion 72a. The short distance means a distance at which the magnetic field can be cancelled. A part of the base portion 73a can be regarded as corresponding to an opposing portion. The portion of base portion 73a that corresponds to the opposing portion can be regarded as a portion that faces base portion 71a and base portion 72a within a short distance range.

### Effects

As shown by the two-dot chain line in FIG. 2, the inverter circuit 100 has the M bus bar 73 arranged between the P bus bar 71 and the N bus bar 72, and has the base portion 73a opposing the P bus bar 71 and the N bus bar 72. Therefore, the inverter circuit 100 can cancel out the magnetic field (a) between the P bus bar 71 and the base portion 73a of the M bus bar 73, and (b) between the base portion 73a and the N bus bar 72. Therefore, the inverter circuit 100 can reduce the inductance. In other words, the inverter circuit 100 can reduce the inductance (a) between the P bus bar 71 and the M bus bar 73, and (b) between the M bus bar 73 and the N bus bar 72. Further, the inverter circuit 100 can reduce the inductance, thereby suppressing a surge voltage. Therefore, the inverter circuit 100 can reduce losses.

It should be noted that the other embodiments are similar in that a part of the base portion 73a is arranged between the P bus bar 71 and the N bus bar 72 and opposes the P bus bar 71 and the N bus bar 72. Therefore, in the other embodiments, similar to the present embodiment, the inductance is reducible.

The embodiment of the present disclosure has been described above. However, the present disclosure is not limited to the above embodiment. Various modifications may be made without departing from the scope and spirit of the present disclosure. Hereinafter, second to twelfth embodiments will be described as other embodiments of the present disclosure. The above-described embodiment and the second to twelfth embodiments can be implemented independently, or can be implemented in appropriate combination. The present disclosure is not limited to the combinations described in the embodiments, and may be implemented in various combinations.

In the following embodiments, differences from the previously-described embodiment will be mainly described. The second to sixth embodiments are different from the first embodiment mainly in (a) the positional relationship between the PM capacitor 30 and the MN capacitor 40 and (b) the configurations of the bus bars 71 to 73. The seventh embodiment differs from the first embodiment mainly in that a PN capacitor 50 is provided.

### Second Embodiment

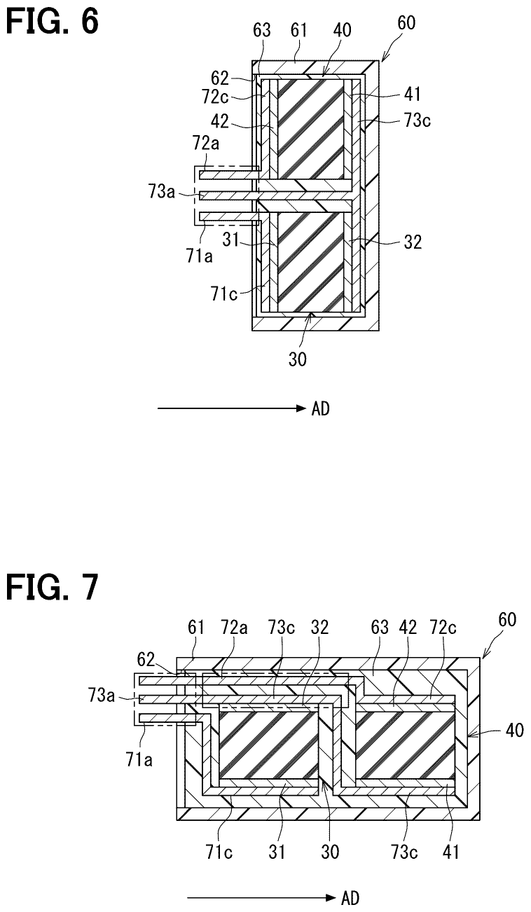

An inverter circuit 100 according to a second embodiment will be described with reference to FIG. 6. In FIG. 6, bus bars 71 to 73 are partially illustrated. The sane also applies to the third to sixth embodiments described later.

A PM capacitor 30 and an MN capacitor 40 are stacked in a direction perpendicular to an arrangement direction AD. Further, the PM capacitor 30 and the MN capacitor 40 are arranged so that their side walls face each other. The side wall of the PM capacitor 30 is a wall surface that is continuous with a first PM terminal 31 and a second PM terminal 32. The MN capacitor 40 is a wall surface that is continuous with a first MN terminal 41 and a second MN terminal 42.

The second PM terminal 32 and the first MN terminal 41 are arranged along an imaginary plane perpendicular to the arrangement direction AD. Similarly, the first PM terminal 31 and the second MN terminal 42 are arranged along another imaginary plane perpendicular to the arrangement direction AD. The second PM terminal 32 and the first MN terminal 41 are arranged closer to a bottom of a capacitor case 61 than the first PM terminal 31 and the second MN terminal 42. The bottom of the capacitor case 61 is the position facing the opening 62.

The P bus bar 71 is bent from one end of a base portion 71a to provide a capacitor connection portion 71c. The capacitor connection portion 71c is connected to the first PM terminal 31. The capacitor connection portion 71c and the first PM terminal 31 are connected by welding or the like.

An N bus bar 72 is bent from one end of a base portion 72a to provide a capacitor connection portion 72c. The capacitor connection portion 72c is connected to the second MN terminal 42. The capacitor connection portion 72c and the second MN terminal 42 are connected by welding or the like.

An M bus bar 73 has a base portion 73a that is provided along the arrangement direction AD. The M bus bar 73 has a capacitor connection portion 73c provided at a tip of the base portion 73a. The M bus bar 73 is provided with the capacitor connection portion 73c connected to the second PM terminal 32 and the capacitor connection portion 73c connected to the first MN terminal 41. In other words, the M bus bar 73 is provided with two capacitor connection portions 73c. The two capacitor connection portions 73c are provided perpendicular to the arrangement direction AD. The capacitor connection portion 73c is connected to the second PM terminal 32 and the first MN terminal 41 by welding.

The base portion 73a is provided so as to protrude from a position between the two capacitor connection portions 73c. The base portion 73a has a portion sandwiched between the PM capacitor 30 and the MN capacitor 40. In other words, a part of the base portion 73a is arranged between the side wall of the PM capacitor 30 and the side wall of the MN capacitor 40. The base portion 73a does not contact those side walls.

In the inverter circuit 100, terminals 31, 32 of the PM capacitor 30 and terminals 41, 42 of the MN capacitor 40 are not arranged to face each other. Therefore, the inverter circuit 100 can easily connect the terminals 31, 32, 41, and 42 to the capacitor connection portions 71c to 73c.

### Third Embodiment

An inverter circuit 100 according to a third embodiment will be described with reference to FIG. 7. A PM capacitor 30 and an MN capacitor 40 are arranged side by side along an arrangement direction AD. Further, the PM capacitor 30 and the MN capacitor 40 are arranged so that their side walls face each other. A second PM terminal 32 and a second MN terminal 42 are arranged along the arrangement direction AD. Similarly, a first PM terminal 31 and a first MN terminal 41 are arranged along the arrangement direction AD. In other words, the second PM terminal 32 and the second MN terminal 42 are arranged on the same imaginary plane along the arrangement direction AD. The first PM terminal 31 and the first MN terminal 41 are arranged on the same imaginary plane along the arrangement direction AD. The two imaginary planes are located at different positions in a direction perpendicular to the arrangement direction AD. The MN capacitor 40 is arranged closer to a bottom of a capacitor case 61 than the PM capacitor 30.

An M bus bar 73 is provided with a capacitor connection portion 73c connected to the second PM terminal 32 and the capacitor connection portion 73c connected to the first MN terminal 41. In other words, the M bus bar 73 is provided with two capacitor connection portions 73c. The M bus bar 73 is provided with one capacitor connection portion 73c via a bent portion relative to the other capacitor connection portion 73c. The M bus bar 73 has a portion (connecting portion) that connects the two capacitor connection portions 73c. The connecting portion is arranged between the PM capacitor 30 and the MN capacitor 40. Note that the two capacitor connection portions 73c are different portions of a single metal plate. Therefore, the connecting portion can be said to be an intermediate portion between the two capacitor connection portions 73c.

As shown by a two-dot chain line in FIG. 7, the inverter circuit 100 can be arranged such that the base portion 72a and the capacitor connection portion 73c face each other on the PM capacitor 30. Therefore, the inverter circuit 100 can further reduce the inductance between an N bus bar 72 and the M bus bar 73.

Further, in the inverter circuit 100, the PM capacitors 30 and the MN capacitors 40 are arranged along the arrangement direction AD. Therefore, the inverter circuit 100 can be made low-profile in a direction perpendicular to the arrangement direction AD.

### Fourth Embodiment

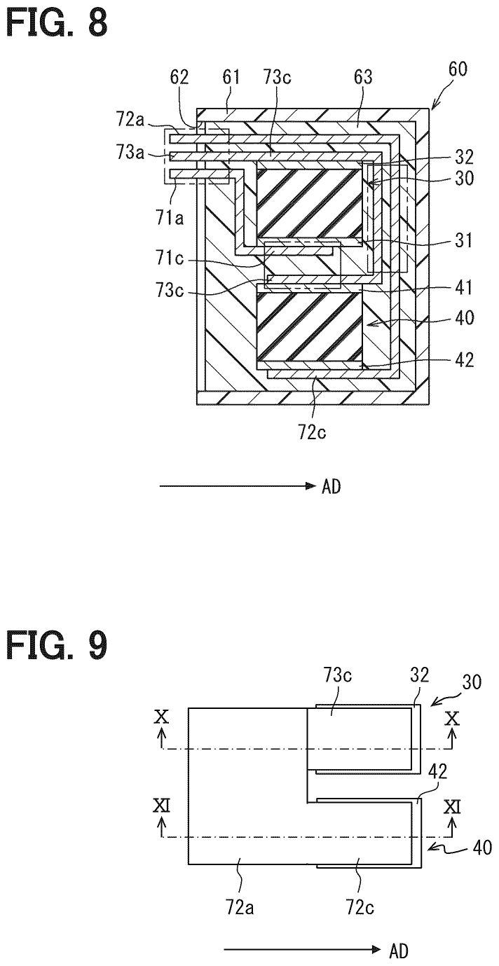

An inverter circuit 100 according to a fourth embodiment will be described with reference to FIG. 8. A PM capacitor 30 and an MN capacitor 40 are stacked in a direction perpendicular to an arrangement direction AD. Further, the PM capacitor 30 and the MN capacitor 40 are stacked so that a first PM terminal 31 and a first MN terminal 41 face each other.

An M bus bar 73 is provided with a capacitor connection portion 73c connected to a second PM terminal 32 and a capacitor connection portion 73c connected to the first MN terminal 41. The M bus bar 73 has a portion (connecting portion) that connects the two capacitor connection portions 73c. The capacitor connection portion 73c connected to the first MN terminal 41 is arranged in an area where the PM capacitor 30 and the MN capacitor 40 face each other. Further, the connecting portion and a base portion 72a are arranged between the capacitors 30, 40 and a bottom of a capacitor case 61.

In the inverter circuit 100, a capacitor connection portion 71c and the capacitor connection portion 73c can be arranged to face each other at a position between the capacitors 30 and 40, as indicated by a two-dot chain line in FIG. 8. Therefore, the inverter circuit 100 can further reduce the inductance between the P bus bar 71 and the M bus bar 73.

Further, in the inverter circuit 100, the base portion 72a of an N bus bar 72 and the connecting portion of the M bus bar 73 can be arranged to face each other at a position between the capacitors 30, 40 and the bottom of the capacitor case 61. Therefore, the inverter circuit 100 can further reduce the inductance between an N bus bar 72 and the M bus bar 73. It should be noted that the inverter circuit 100 can achieve the same effects even when the PM capacitor 30 and the MN capacitor 40 are stacked such that the second PM terminal 32 and the second MN terminal 42 face each other.

### Fifth Embodiment

An inverter circuit 100 according to a fifth embodiment will be described with reference to FIGS. 9 to 11. In FIG. 9, in order to simplify the drawing, a capacitor case 61 and a sealing resin 63 are omitted.

As shown in FIG. 9, a PM capacitor 30 and an MN capacitor 40 are arranged side by side in a direction perpendicular to an arrangement direction AD. Further, the PM capacitor 30 and the MN capacitor 40 are arranged so that their side walls face each other. A second PM terminal 32 and a second MN terminal 42 are arranged along the perpendicular direction. Similarly, a first PM terminal 31 and a first MN terminal 41 are arranged along the perpendicular direction. The PM capacitor 30 and the MN capacitor 40 are arranged at the same position in a depth direction of the capacitor case 61.

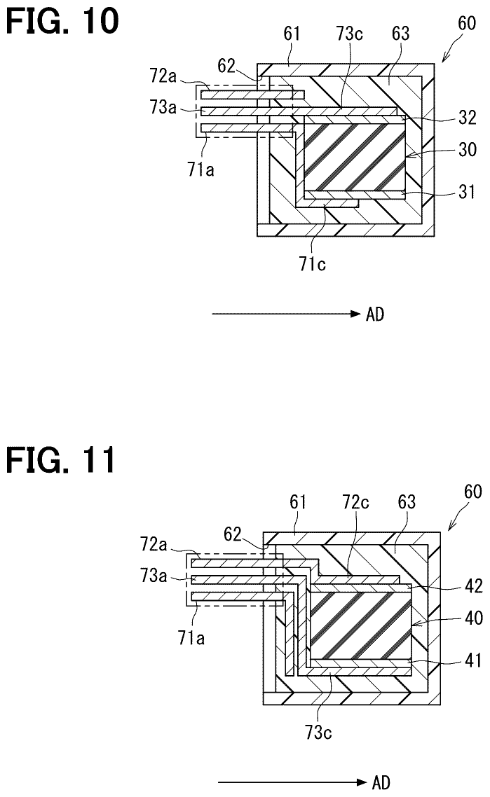

As shown in FIGS. 10 and 11, an M bus bar 73 is provided with a capacitor connection portion 73c connected to the second PM terminal 32 and a capacitor connection portion 73c connected to the first MN terminal 41. The M bus bar 73 has a portion (connecting portion) that connects the two capacitor connection portions 73c. The connecting portion is arranged along an arrangement direction of the PM capacitor 30 and the MN capacitor 40. The inverter circuit 100 can be made smaller than that in the first embodiment.

### Sixth Embodiment

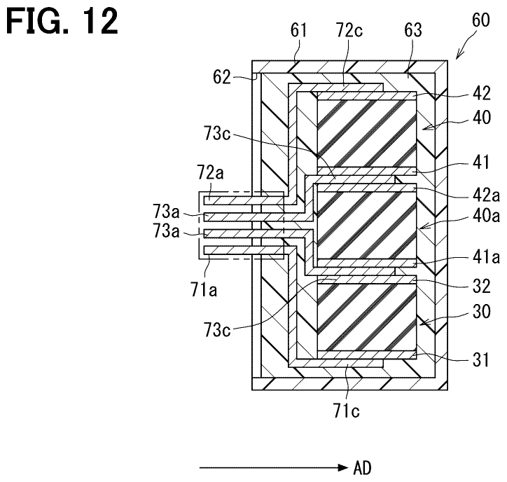

An inverter circuit 100 according to a sixth embodiment will be described with reference to FIG. 12. In the present embodiment, a four-level inverter circuit 100 is employed. The inverter circuit 100 includes an MM capacitor 40a, in addition to a PM capacitor 30 and an MN capacitor 40. The MM capacitor 40a is connected in series with the PM capacitor 30 and the MN capacitor 40. The MM capacitor 40a has a first MM terminal 41a and a second MM terminal 42a. The first MM terminal 41a is arranged to face a second PM terminal 32. The second MM terminal 42a is arranged to face the first MN terminal 41.

The inverter circuit 100 includes two M bus bars 73. One of the M bus bars 73 has a capacitor connection portion 73c connected to the second PM terminal 32 and the first MM terminal 41a. The other M bus bar 73 has a capacitor connection portion 73c connected to the first MN terminal 41 and the second MM terminal 42a.

Base portions 73a of the two M bus bars 73 are arranged between a semiconductor device 20 and the capacitors 30 and 40. A part of the base portion 73a is arranged between a P bus bar 71 and an N bus bar 72, and opposes the P bus bar 71 and the N bus bar 72. Therefore, it can be said that the two M bus bars 73 each have an opposing portion. The inverter circuit 100 can also be applied to a multilevel inverter having four or more levels.

### Seventh Embodiment

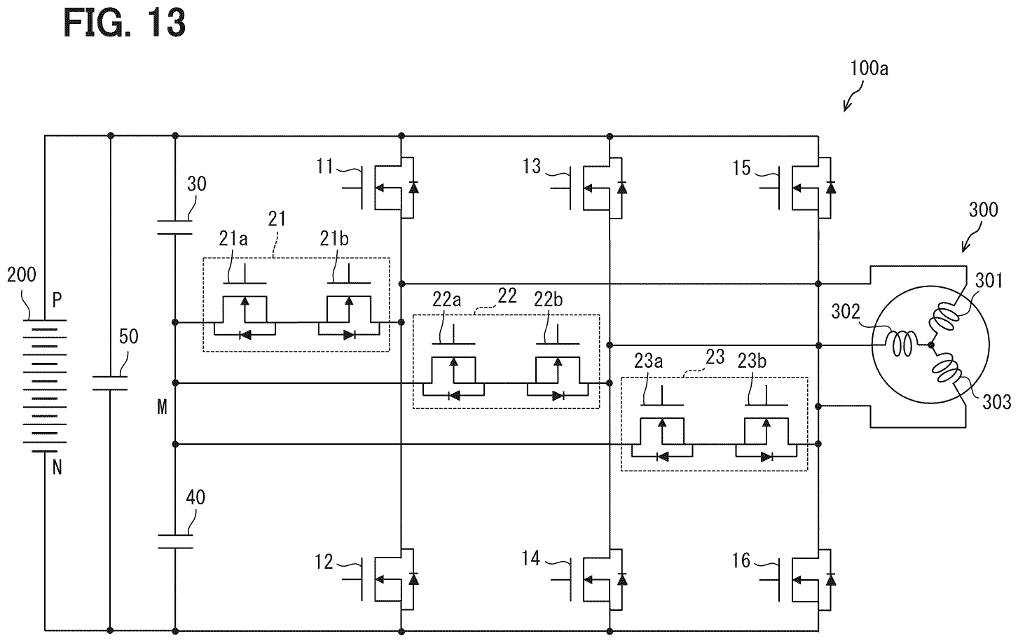

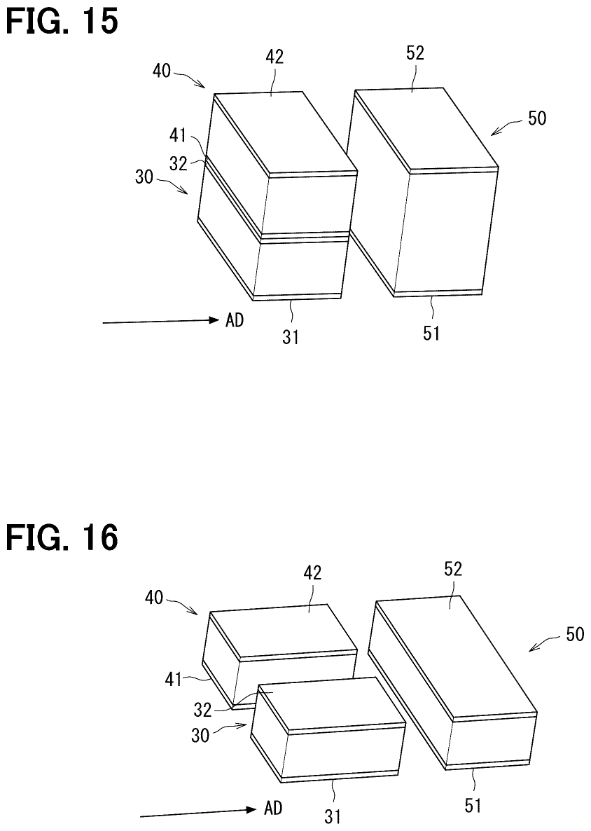

A structure of an inverter circuit 100a of a seventh embodiment will be described with reference to FIGS. 13 to 15. The inverter circuit 100a differs from the inverter circuit 100 in that a PN capacitor 50 is provided. In FIG. 15, bus bars 71 to 73, an insulating member 80, and the like are omitted. The same applies to FIG. 16 which will be described later.

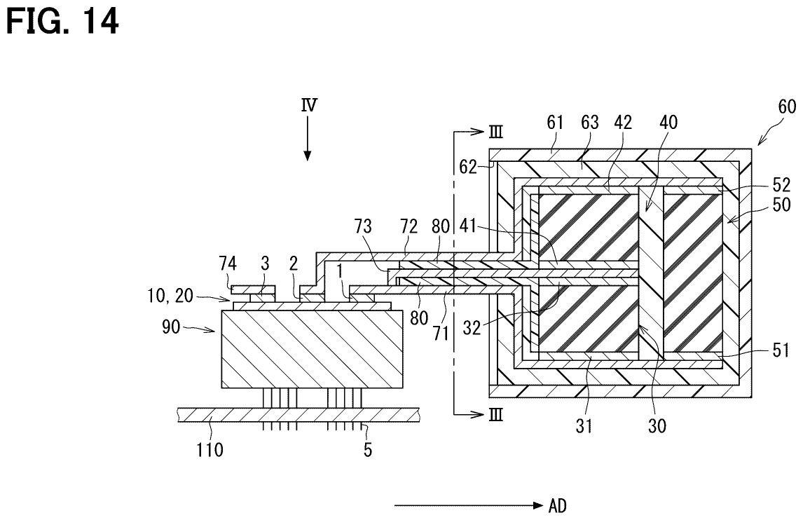

As shown in FIGS. 13 and 14, in the inverter circuit 100a, a PN capacitor 50 is connected between a P bus bar 71 and an N bus bar 72. The PN capacitor 50 is connected to a high-potential terminal and a low-potential terminal. Therefore, the PN capacitor 50 is connected in parallel to a PM capacitor 30 and an MN capacitor 40. The PN capacitor 50 is provided for current ripple absorption. In other words, the PN capacitor 50 is provided to reduce a current ripple that flows out of the inverter circuit 100a. The PN capacitor 50 corresponds to a third capacitor.

In the inverter circuit 100a, a capacitance of the capacitor required to suppress an allowable voltage fluctuation at a midpoint M is small, whereas a capacitance of the capacitor required to reduce the current ripple flowing out to the outside is large. Therefore, the inverter circuit 100a is provided with the PN capacitor 50. The PN capacitor 50 is connected in parallel with the PM capacitor 30 and the MN capacitor 40 as described above. Therefore, the inverter circuit 100a can reduce a total capacitance of the PM capacitor 30, the MN capacitor 40, and the PN capacitor 50. Therefore, in the inverter circuit 100a, the PM capacitor 30, the MN capacitor 40, and the PN capacitor 50 are made to have a smaller volume.

As shown in FIG. 14, a capacitor device 60 includes the PN capacitor 50, in addition to the PM capacitor 30, the MN capacitor 40, a capacitor case 61, and a sealing resin 63. The PN capacitor 50 is accommodated in the capacitor case 61 together with the PM capacitor 30 and the MN capacitor 40. The PN capacitor 50 is sealed with the sealing resin 63. Further, as shown in FIGS. 14 and 15, the PN capacitor 50 is arranged in an arrangement direction AD with respect to the PM capacitor 30 and the MN capacitor 40.

The PN capacitor 50 has a first PN terminal 51 and a second PN terminal 52. The first PN terminal 51 is connected to the P bus bar 71. The second PN terminal 52 is connected to the N bus bar 72.

The PM capacitor 30 and the MN capacitor 40 are positioned closer to a cooler 90 than the PN capacitor 50. In the present embodiment, as an example, the cooler 90, the PM capacitor 30, the MN capacitor 40, and the PN capacitor 50 are arranged in this order along the arrangement direction AD. Therefore, the PM capacitor 30 and the MN capacitor 40 are more easily cooled by the cooler 90 than the PN capacitor 50. It can be said that, in the inverter circuit 100a, the PM capacitor 30 and the MN capacitor 40 receive a stronger cooling power than the PN capacitor 50.

Further, in the P bus bar 71, a length from a connection portion with a structured body to a connection portion with the PM capacitor 30 is shorter than a length from a connection portion with the structured body to a connection portion with the PN capacitor 50. Therefore, the PM capacitor 30 cooled by the P bus bar 71 that is cooled by the cooler 90 is more easily coolable than the PN capacitor 50.

On the other hand, in the N bus bar 72, a length from a connection portion with the structured body to a connection portion with the MN capacitor 40 is shorter than a length from a connection portion with the structured body to a connection portion with the PN capacitor 50. Therefore, the MN capacitor 40 cooled by the N bus bar 72 that is cooled by the cooler 90 is more easily coolable than the PN capacitor 50.

In the mean time, a ripple current caused by heat generation is larger in the PM capacitor 30 and the MN capacitor 40 than in the PN capacitor 50. Therefore, in the present disclosure, the PM capacitor 30 and the MN capacitor 40 are arranged closer to the cooler 90 than the PN capacitor 50. Therefore, the inverter circuit 100a can suppress the heat generated in the PM capacitor 30 and the MN capacitor 40. Therefore, the inverter circuit 100a can increase an allowable current of the PM capacitor 30 and the MN capacitor 40. In other words, the inverter circuit 100a can have an increase in the allowable current than a configuration in which the PN capacitor 50 is positioned closer to the cooler 90 than the PM capacitor 30 and the MN capacitor 40. The positional relationship between the cooler 90 and each of the capacitors 30 to 50 described above can also be applied to other embodiments.

The P bus bar 71 and the N bus bar 72 may have a higher thermal conductivity at portions connected to the PM capacitor 30 and the MN capacitor 40 than at portions connected to the PN capacitor 50. For example, the portion connected to the PN capacitor 50 is made mainly of copper. On the other hand, the portions connected to the PM capacitor 30 and the MN capacitor 40 are made mainly of silver. In such manner, the inverter circuit 100a can also have an increase in the allowable current of the PM capacitor 30 and the MN capacitor 40.

In the following embodiments, differences from the seventh embodiment will be mainly described.

### Eighth Embodiment

An inverter circuit 100a according to an eighth embodiment will be described with reference to FIG. 16. The present embodiment differs from the seventh embodiment in the positional relationship between a PM capacitor 30 and an MN capacitor 40.

The PM capacitor 30 and the MN capacitor 40 are arranged in parallel. The PM capacitor 30 and the MN capacitor 40 are arranged such that a first PM terminal 31 and a first MN terminal 41 are on the same imaginary plane. The PM capacitor 30 and the MN capacitor 40 are arranged such that a second PM terminal 32 and a second MN terminal 42 are arranged on the same imaginary plane.

Therefore, the inverter circuit 100a can have a smaller volume in a direction perpendicular to a capacitor arrangement direction of the PM capacitor 30 and the MN capacitor 40 than a configuration in which both capacitors 30, 40 are arranged in a stacked manner. Further, in the inverter circuit 100a, similarly to the first embodiment, the size of each of the capacitors 30 to 50 is reducible. It should be noted that the PN capacitor 50 is arranged in parallel with both of the PM capacitor 30 and the MN capacitor 40. A first PN terminal 51 is arranged on the same imaginary plane as the first PM terminal 31 and the first MN terminal 41. A second PN terminal 52 is arranged on the same imaginary plane as the second PM terminal 32 and the second MN terminal 42.

### Ninth Embodiment

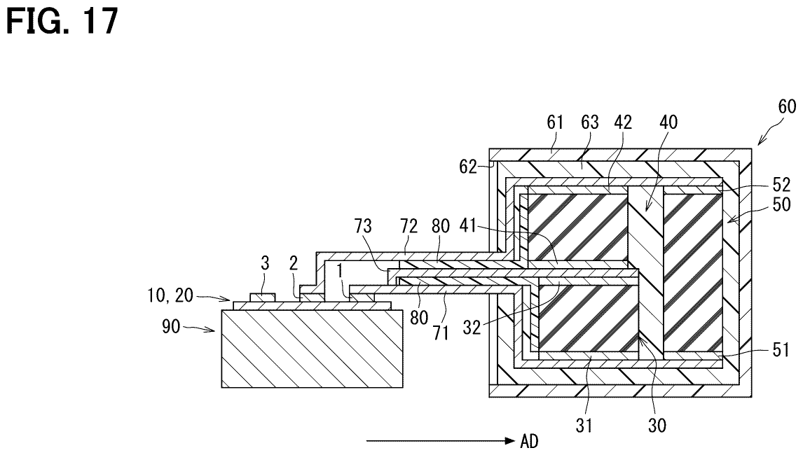

An inverter circuit 100a according to a ninth embodiment will be described with reference to FIG. 17. The present embodiment differs from the first embodiment in the positional relationship between a PM capacitor 30 and an MN capacitor 40. The PM capacitor 30 and the MN capacitor 40 are arranged in a shifted manner along an arrangement direction AD. In the inverter circuit 100a, similarly to the seventh embodiment, a volume of each of the capacitors 30 to 50 is reducible.

### Tenth Embodiment

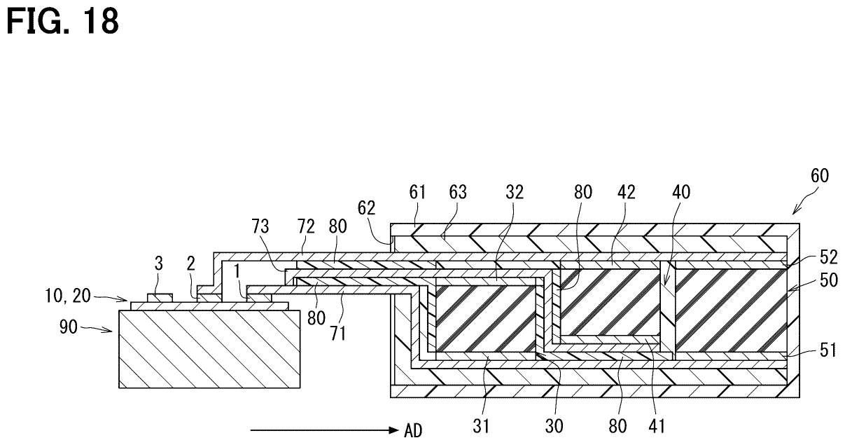

An inverter circuit 100a according to a tenth embodiment will be described with reference to FIG. 18. In the present embodiment, portions different from the eighth embodiment will be mainly described. The present embodiment differs from the eighth embodiment in the positional relationship of a PN capacitor 50 with respect to a PM capacitor 30 and an MN capacitor 40.

The PN capacitor 50 is arranged in parallel with the PM capacitor 30 and the MN capacitor 40. In other words, the PM capacitor 30, the MN capacitor 40, and the PN capacitor 50 are arranged in a straight line.

Therefore, the inverter circuit 100a can have a smaller volume in a direction perpendicular to a capacitor arrangement direction of the capacitors 30 to 50 than a configuration in which the capacitors 30 to 50 are arranged in a stacked manner. Further, in the inverter circuit 100a, similarly to the seventh embodiment, a volume of each of the capacitors 30 to 50 is reducible.

### Eleventh Embodiment

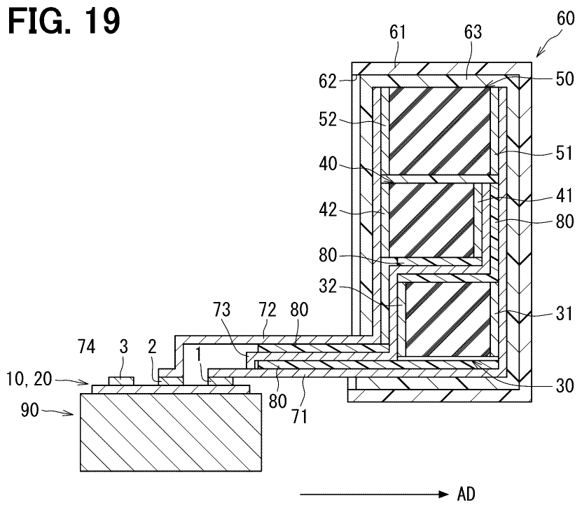

An inverter circuit 100a according to an eleventh embodiment will be described with reference to FIG. 19. The present embodiment differs from the seventh embodiment in the positional relationship of a PN capacitor 50 with respect to a PM capacitor 30 and an MN capacitor 40.

The PN capacitor 50 is arranged in a stacked manner together with the PM capacitor 30 and the MN capacitor 40. Further, the capacitors 30 to 50 are arranged so that their terminals do not face each other. A first PN terminal 51 is arranged parallel to a first PM terminal 31 and a first MN terminal 41 with respect to the same imaginary plane. A second PN terminal 52 is arranged parallel to a second PM terminal 32 and a second MN terminal 42 with respect to the same imaginary plane. The inverter circuit 100a can have a smaller volume in a direction perpendicular to a capacitor arrangement direction of the capacitors 30 to 50 than a configuration in which the capacitors 30 to 50 are arranged in parallel. Further, in the inverter circuit 100a, similarly to the seventh embodiment, a volume of each of the capacitors 30 to 50 is reducible.

### Twelfth Embodiment

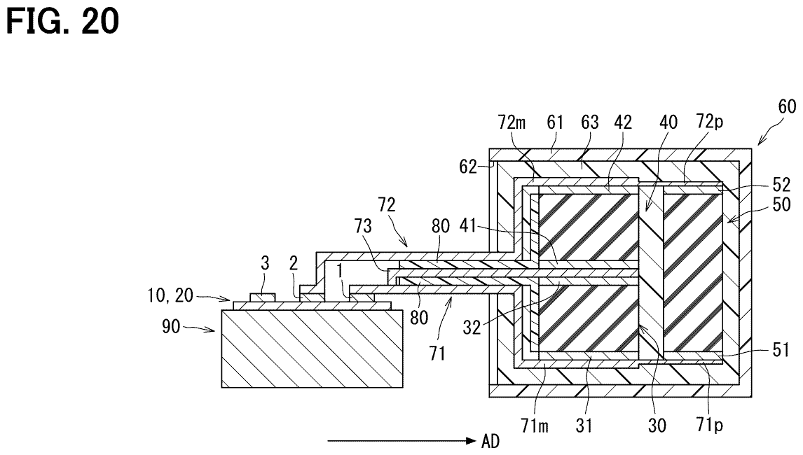

An inverter circuit 100a according to a twelfth embodiment will be described with reference to FIG. 20. The present embodiment differs from the seventh embodiment in the configurations of a P bus bar 71 and an N bus bar 72.

The P bus bar 71 includes a PM bus bar portion 71m connected to a PM capacitor 30 and a PN bus bar portion 71p connected to a PN capacitor 50. The N bus bar 72 includes an MN bus bar portion 72m connected to a MN capacitor 40 and a PN bus bar portion 72p connected to the PN capacitor 50. The PM bus bar portion 71m has a larger cross-sectional area than the PN bus bar portion 71p. The MN bus bar portion 72m has a larger cross-sectional area than the PN bus bar portion 72p.

In such manner, the inverter circuit 100a can have an increase in an allowable current of the PM capacitor 30 and the MN capacitor 40. Further, in the inverter circuit 100a, similarly to the seventh embodiment, a volume of each of the capacitors 30 to 50 is reducible.

Although the present disclosure is described in accordance with the embodiments, it is understood that the present disclosure is not limited to the above-described embodiments and structures. The present disclosure encompasses various modification examples or variations within the scope of equivalents. Further, while various combinations and modes are described in the present disclosure, other combinations and modes including only one or more elements added thereto or subtracted therefrom are also within the scope and spirit of the present disclosure.

What is claimed is:

1. A power conversion device capable of dividing an input DC voltage into a plurality of values and outputting a plurality of levels of voltage through an output wiring, the power conversion device comprising:
a high-potential wiring connected to a positive electrode of a power source;
a low-potential wiring connected to a negative electrode of the power source;
at least one midpoint wiring having a potential between the high-potential wiring and the low-potential wiring;
a first power module connected to the high-potential wiring, the low-potential wiring, and the output wiring;
a first capacitor having a high potential electrode connected to the high-potential wiring and a first midpoint electrode connected to the midpoint wiring;
a second capacitor having a low potential electrode connected to the low-potential wiring and a second midpoint electrode connected to the midpoint wiring; and
a second power module connected to the midpoint wiring and the output wiring, wherein
the at least one midpoint wiring is a part between (i) the second power module and (ii) the first capacitor and the second capacitor, is arranged between the high-potential wiring and the low-potential wiring, and has an opposing portion opposing the high-potential wiring and the low-potential wiring.

2. The power conversion device according to claim 1, wherein
the first capacitor and the second capacitor are arranged to have the first midpoint electrode and the second midpoint electrode facing each other, and
the midpoint wiring is sandwiched between the first capacitor and the second capacitor, and has a connection portion connected to the first midpoint electrode and the second midpoint electrode.

3. The power conversion device according to claim 1, wherein
the midpoint wiring includes: a connection portion connected to the first midpoint electrode and the second midpoint electrode; and a portion protruding from the connection portion and sandwiched between the first capacitor and the second capacitor.

4. The power conversion device according to claim 1, wherein
the first capacitor and the second capacitor are arranged to have a first side surface connected to the first midpoint electrode and the high potential electrode, and a second side surface opposing the first side surface and connected to the second midpoint electrode and the low potential electrode, and
the midpoint wiring has two connection portions connected to the first midpoint electrode and the second midpoint electrode, and a portion connecting the two connection portions is arranged between the first capacitor and the second capacitor.

5. The power conversion device according to claim 1, wherein
the first capacitor and the second capacitor are arranged to have (i) the first midpoint electrode and the low potential electrode facing each other or (ii) the second midpoint electrode and the high potential electrode facing each other,
the midpoint wiring has two connection portions connected to the first midpoint electrode and the second midpoint electrode, and
one of the two connection portions is arranged in an area where the first capacitor and the second capacitor face each other.

6. The power conversion device according to claim 1, wherein
the first capacitor and the second capacitor are arranged to have a first side surface connected to the first midpoint electrode and the high potential electrode, and a second side surface opposing the first side surface and connected to the second midpoint electrode and the low potential electrode, and
the midpoint wiring has two connection portions connected to the first midpoint electrode and the second midpoint electrode, and a portion connecting the two connection portions is arranged along an arrangement direction of the first capacitor and the second capacitor.

7. The power conversion device according to claim 1, wherein
each of at least two midpoint wirings has the opposing portion.

8. The power conversion device according to claim 1, further comprising:
at least one third capacitor connected to the high-potential wiring and the low-potential wiring.

9. A power conversion device capable of dividing an input DC voltage into a plurality of values and outputting a plurality of levels of voltage through an output wiring, the power conversion device comprising:
a high-potential wiring connected to a positive electrode of a power source;
a low-potential wiring connected to a negative electrode of the power source;
at least one midpoint wiring having a potential between the high-potential wiring and the low-potential wiring;
a first power module connected to the high-potential wiring, the low-potential wiring, and the output wiring;
a first capacitor having a high potential electrode connected to the high-potential wiring and a first midpoint electrode connected to the midpoint wiring;
a second capacitor having a low potential electrode connected to the low-potential wiring and a second midpoint electrode connected to the midpoint wiring; and
a second power module connected to the midpoint wiring and the output wiring, wherein
the midpoint wiring is arranged between the high-potential wiring and the low-potential wiring, and has an opposing portion opposing the high-potential wiring and the low-potential wiring,
the first capacitor and the second capacitor are arranged to have the first midpoint electrode and the second midpoint electrode facing each other, and
the midpoint wiring is sandwiched between the first capacitor and the second capacitor, and has a connection portion connected to the first midpoint electrode and the second midpoint electrode.
